(19) United States
(12) Patent Application Publication
(10) Pub. No.: US 2013/0054339 A1
(43) Pub. Date: Feb. 28, 2013

(54) Method and system for implementing a collaborative customer service model

(71) Applicants: Mukul Gupta, Croydon (GB); Mandeep Singh Kwatra, Ipswich (GB); Senthil Kumar Murlidharan, Coimbatore (IN); Vivek Chadha, Wanowari (IN); Damandeep Singh Soni, Goa (IN)

(72) Inventors: Mukul Gupta, Croydon (GB); Mandeep Singh Kwatra, Ipswich (GB); Senthil Kumar Murlidharan, Coimbatore (IN); Vivek Chadha, Wanowari (IN); Damandeep Singh Soni, Goa (IN)

(73) Assignee: INFOSYS LIMITED, Bangalore (IN)

(21) Appl. No.: 13/313,322

(22) Filed: Dec. 7, 2011

(30) Foreign Application Priority Data
Aug. 26, 2011 (IN) 2921/CHE/2011

(51) Int. Cl. G06Q 10/00; G06Q 30/02

(52) U.S. Cl. 705/14.27; 705/304

(57) ABSTRACT

A method for processing customer service query requested by a customer is provided. The customer service query relates to at least one of one or more products and services. The method enables receiving the customer service query. The customer service query is received through an Integrated Voice Response system. The method further enables directing the customer to access a web-based software platform for submitting the query to at least one of an electronic knowledge repository and a social networking software platform. Furthermore, the method enables providing query response to the customer via at least one of the electronic knowledge repository and the social networking platform. The method further enables automatically routing the query to one or more contact center agents and providing query response via a contact center agent, if the query remains unaddressed via the electronic knowledge repository and the social networking software platform.

### FIELD OF INVENTION

The present invention generally relates to customer relationship management. More specifically, the present invention relates to a system and method that implements a collaborative customer service model integrating the concepts of web self-service, live customer service and social networking based customer service.

### BACKGROUND OF THE INVENTION

Customer service is an integral aspect of customer relationship management in any industry. In the last few years, growth in sales volumes due to constantly rising demand for manufactured products and services has made customer service a necessary part of business. In addition to the basic business objectives of growth, operational efficiency and profitability, vital objectives of any organization further include customer satisfaction, customer loyalty and customer stickiness. These objectives are largely driven by having an ‘engaged customer’ whose needs are easily met. After having purchased a product or a service from a business establishment, customers nowadays demand a high level of customer service from the company. Further, an increase in complexity of manufactured products and services and the faster introduction of more and more new products and services in the market have necessitated the implementation of a highly efficient customer service model in order to meet customer expectations.

Although various organizations are allocating significant amount of resources to manage customer service, the level of customer satisfaction has been constantly declining. The traditional model of customer service based on setting-up contact centers and employing customer service representatives has failed to satisfactorily address growing customer service demands. Contact centers mainly rely on trained customer service representatives, who have the expertise to ‘sense’ the root cause of a problem and accordingly, diagnose and fix the problem. However, customers expect that the first customer service representative whom they contact should have the requisite knowledge, tools and capabilities required to address their needs, which is seldom the case. More often than not, the problem is eventually resolved only after the customer has been forwarded to multiple customer service representatives. Thus, the average time for resolution of a problem is undesirably high. Further, the aforementioned process is primarily manual and highly person-dependant. This adversely affects three important parameters of customer service quality, i.e. response time, accuracy of resolution, and cost to company. Moreover, the loss of trained customer service representatives due to attrition or superannuation results in their knowledge being lost by the organization. Accordingly, there is a need to optimize customer service processes to achieve increased customer satisfaction.

Furthermore, during events such as new product launches, new marketing campaigns, and bug-outbreaks, contact centers experience distinct spikes in customer service demands. Various organizations attempt to address such spikes through recruiting subject matter experts on a temporary basis, which is quite an expensive solution.

A contemporary customer service approach used for resolving queries includes allowing web-enabled customers to submit online queries. A web-enabled customer service representative provides an electronic response, such as through electronic email, to an online query based on his expertise. However, in some cases if the representative does not have requisite knowledge, the query may remain unresolved.

In light of the foregoing, there is a need to optimize customer service process in order to achieve increased customer satisfaction with improved cost efficiency. Also, there is a need to enhance customer experience through wide and ready availability of customer service. Moreover, a definite mechanism for resolution of customer queries needs to be established so that queries do not remain unresolved.

### SUMMARY OF THE INVENTION

A method for processing customer service query requested by a customer is provided. The customer service query relates to at least one of one or more products and services. In various embodiments of the present invention, the method comprises receiving the customer service query. The customer service query is received through an Integrated Voice Response system. The method further comprises directing the customer to access a web-based software platform for submitting the query to at least one of an electronic knowledge repository and a social networking software platform. Furthermore, the method comprises providing query response to the customer via at least one of the electronic knowledge repository and the social networking platform. The method further comprises automatically routing the query to one or more contact center agents and providing query response via a contact center agent, if the query remains unaddressed via the electronic knowledge repository and the social networking software platform.

In an embodiment of the present invention, providing query response to the customer via the electronic knowledge repository comprises automatically traversing relevant ontology in the knowledge repository based on subject matter of the query. The method comprises extracting desired information from the repository and displaying extracted information to the customer on a user interface.

In another embodiment of the present invention, the electronic knowledge repository comprises one or more ontologies corresponding to one or more products and services. The ontology contains knowledge related to a product or a service in the form of pre-defined scenarios and their solutions.

In an embodiment of the present invention, the pre-defined scenarios associated with the one or more ontologies are characterized using Bayesian networks.

In an embodiment of the present invention, providing query response to the customer via social networking software platform comprises posting the customer service query to a relevant social network based on subject matter of the query. The method further comprises directing the customer to access the social network through a user interface. The social network comprises one or more message boards and further the one or more message boards are configured to publish the query and to publish solutions to the query submitted by subscribers.

In an embodiment of the present invention, the method further comprises implementing an incentive mechanism to encourage users to actively participate in the social network in order to submit queries and to provide answers to queries. Implementing the incentive mechanism comprises assigning reward points to users for performing activities indicating user participation in the social network. The reward points are assigned to users for submitting queries and for answering queries submitted by other users.

In an embodiment of the present invention, implementing the incentive mechanism further comprises allotting additional reward points to users submitting responses to queries based on rating of response and response time and facilitating redemption of reward points accumulated by a user in return for digital gifts.

In an embodiment of the present invention, the query response is provided via a contact center agent using online chat sessions. In another embodiment of the present invention, the method further comprises activating a Service Level Agreement triggered contact center agent callback for providing query response to customer.

An integrated customer service platform for processing customer service queries related to one or more products and services of an organization is provided. The integrated customer service platform comprises an Interactive Voice Response (IVR) system configured to provide audio responses to customers dialing into the system seeking resolution of queries. The IVR system is further configured to direct customers to a web-based software platform for seeking resolution of customer service queries. The integrated customer service platform further comprises a web-based software platform configured to receive queries submitted by customers through user interfaces and further configured to implement one or more web applications for resolution of queries. The web-based software platform comprises a Scenario-based Customer Service (SBCS) Module configured to address queries received by the web-based software platform. The scenario-based customer service module comprises a customer SBCS module configured to process customer service queries by extracting the requested information from a repository. The Scenario-based Customer Service Module further comprises a repository configured to store information related to the one or more products and services in the form of one or more ontologies and a customer service representative SBCS module configured to process customer service queries submitted by customer service representatives. The customer service queries are processed by extracting requested information from the repository. Further, the integrated customer service platform comprises an Event-based Social Networking Module configured to implement a social networking platform employing one or more electronic social networks corresponding to the one or more products and services. The one or more electronic social networks are adapted to maintain electronic message boards for receiving and publishing customer queries, and for receiving and publishing responses to queries.

In an embodiment of the present invention, the repository is dynamically updated with information available in the one or more electronic social networks.

In another embodiment of the present invention, the Event-based Social Networking Module is further configured to implement an incentive mechanism to encourage users to actively participate in the one or more electronic social networks for submitting queries and for providing answers to queries. Further, implementation of the incentive mechanism includes assigning reward points to users for performing activities indicating user participation in the one or more electronic social networks.

A computer program product comprising a computer usable medium having a computer readable program code embodied therein for processing customer service query requested by a customer is provided. The customer service query relates to one or more products and services. The computer program product comprises program instruction means for receiving the customer service query. The customer service query is received through an Integrated Voice Response system. The computer program product comprises program instruction means for directing the customer to access a web-based software platform for submitting the query to at least one of an electronic knowledge repository and a social networking software platform. The computer program product further comprises program instruction means for providing query response to the customer via at least one of the electronic knowledge repository and the social networking platform. Furthermore, the computer program product comprises program instruction means for automatically routing the query to one or more contact center agents and providing query response via a contact center agent, if the query remains unaddressed via the electronic knowledge repository and the social networking software platform.

In an embodiment of the present invention, providing query response to the customer via the electronic knowledge repository comprises program instruction means for automatically traversing relevant ontology in the knowledge repository based on subject matter of the query and extracting desired information from the repository and displaying extracted information to the customer on a user interface. In another embodiment of the present invention, providing query response to the customer via social networking software platform comprises program instruction means for posting the customer service query to a relevant social network based on subject matter of the query. Further, the computer program product comprises program instruction means for directing the customer to access the social network through a user interface. The social network comprises one or more message boards and further wherein the one or more message boards are configured to publish the query and to publish solutions to the query submitted by subscribers.

In an embodiment of the present invention, the computer program product further comprises program instruction means for implementing an incentive mechanism to encourage users to actively participate in the social network in order to submit queries and to provide answers to queries. The step of implementing the incentive mechanism comprises program instruction means for assigning reward points to users for performing activities indicating user participation in the social network. The reward points are assigned to users for submitting queries and for answering queries submitted by other users.

In an embodiment of the present invention, implementing the incentive mechanism further comprises program instruction means for allotting additional reward points to users submitting responses to queries based on rating of response and response time. The computer program product further comprises program instruction means for facilitating redemption of reward points accumulated by a user in return for digital gifts.

In an embodiment of the present invention, the computer program product further comprises program instruction means for activating a Service Level Agreement triggered contact center agent callback for providing query response to customer.

### BRIEF DESCRIPTION OF THE DRAWINGS

The present invention is described by way of embodiments illustrated in the accompanying drawings wherein:

FIG. 1 illustrates an exemplary flowchart outlining the operation of a customer service model implemented for resolving customer queries, in accordance with an embodiment of the present invention;

FIG. 2 is a block diagram depicting an integrated customer service platform implemented for providing customer service solutions, in accordance with various embodiments of the present invention;

FIG. 3 depicts an exemplary user interface enabling search for desired information on the integrated customer service platform, in accordance with an embodiment of the present invention;

FIG. 4 depicts an exemplary user interface enabling submission of query on a social network of the integrated customer service platform, in accordance with an embodiment of the present invention; and

FIG. 5 depicts an exemplary user interface for searching for answers to queries submitted by a user on a social network of the integrated customer service platform, in accordance with an embodiment of the present invention.

### DETAILED DESCRIPTION

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purpose of clarity, details relating to technical material that is known in the technical fields related to the invention have been briefly described or omitted so as not to unnecessarily obscure the present invention.

Embodiments of the present disclosure include systems and methods for implementing a collaborative customer service model. The customer service model of the present invention encourages customers to use a web-based software platform for obtaining responses to queries. Queries directed to the customer service platform get addressed either through multi-level support at the platform (web-based self-service, web-based peer service and online customer agent support) or gets escalated through a time-sensitive process to an agent who can get in touch with the customer through email/call back with a solution.

The present invention would now be discussed in context of embodiments as illustrated in the accompanying drawings.

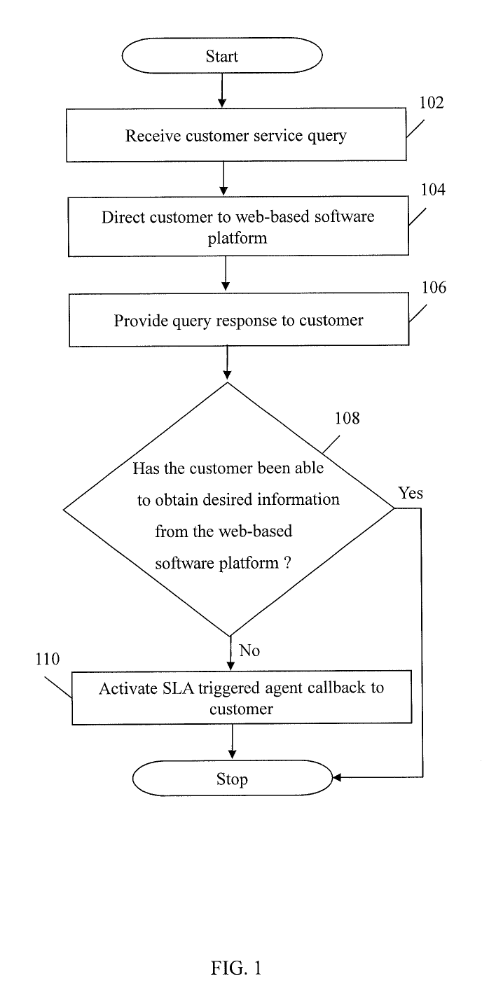

FIG. 1 illustrates an exemplary flowchart outlining the operation of a customer service model implemented for resolving customer queries, in accordance with an embodiment of the present invention. The customer service model disclosed by the system and method of the invention may be used by organizations to resolve queries submitted by customers. For example, a financial services organization may receive customer queries related to account balance, transactions, fund transfers, equity accounts etc. For ensuring resolution of the queries, multiple channels are employed by the method and system of the present invention. Automatic diversion of the query to one or more of the multiple channels is carried out until resolution of the query is achieved. Steps for processing a customer service query, as demonstrated in the figure, include, at step 102, receiving a customer service query by the system of the invention. In various embodiments of the present invention, the system of the invention is a software platform implemented by an organization and configured to integrate the aspects of automated customer service, live customer service and web-based customer service. The customer may seek resolution to a query by calling an Interactive Voice Response (IVR) system of the organization. The IVR system is an automated system which provides responses in the form of pre-recorded audio or dynamically generated audio to customers that dial into the organization's telecommunication system seeking resolution of queries. Upon receipt of customer service query by the system of the invention, at step 104, the customer seeking resolution of the query is directed to use a web-based software platform. The web-based software platform is configured to provide a plurality of software channels to the customer for resolution of the query. The plurality of software channels include, but are not limited to, web-based self-service, web-based peer service, online customer agent support etc. The web-based software platform implements one or more web applications for resolving customer queries.

Thereafter, at step 106, system of the invention provides query response to the customer. Query response is provided to the customer by presenting the customer with one or more means of query resolution.

In an embodiment of the present invention, the web-based software platform provides the customer with access to an online knowledge base for obtaining information for resolving the query. An online knowledge base is an electronic database including comprehensive information related to one or more services offered by the organization. In various embodiments of the present invention, data related to the one or more services provided by an organization are taxonomically arranged and listed in the database. The customer submits a query to the online knowledge base for seeking desired information related to a product/service. The query may be submitted through a web browser configured to access the web-based software platform.

In another embodiment of the present invention implementing web-based peer service, the web-based software platform implements a social networking platform which is configured to enable users to collaborate with each other through online social networks for providing solutions to customer service queries. The social networking platform implements one or more online social networks. Each online social network is built with a well-defined scope in terms of a specific product, a specific service, or a specific technology. Examples of online social networks for a financial services organization may include social networks related to specific services such as Dematerialized accounts, Loan products, Mutual Fund products, Third Party Transfers etc. Users of an online social network may include individuals interested in the specific product, the specific service, or the specific technology who are subscribers of the social network. Users may also include technology/product experts who are suitably informed to submit solutions to queries posted on the network. For a query which is not addressed in the online knowledge base accessible to the customer, the system of the invention posts the query to a relevant social network. Further, based on the subject of a query posed by a customer, the customer is routed to the relevant online social network. The online social network comprises one or more message boards where the query is published. Users who have subscribed to the social network have access to the query and can submit solutions to the query which can then be accessed by the customer. In various embodiments of the present invention, the users submitting solutions to the query may include technology experts/product experts/subject matter experts. In certain embodiments of the present invention, an incentive mechanism is implemented to encourage users to actively participate in social networks and submit solutions to queries.

In yet another embodiment of the present invention, queries which remain unaddressed either through the online knowledge base or in any online social network are routed to online contact center agents who are equipped to address the queries. In an embodiment of the present invention, a customer can engage in online chat sessions with contact center agents for effective query resolution. In another embodiment of the present invention, contact center agents can also submit queries to the online knowledge base and receive responses to the queries. Further, query responses can be provided to customers through calls, emails, online chat sessions etc.

The customer can obtain desired information with respect to a query from the web-based platform through any of the means disclosed above. However, it is possible in some cases that the customer is unable to obtain desired information through the above mentioned means of web-based self service, web-based peer service and online customer agent support. If it is determined at step 108 that a customer has not been able to obtain desired information within a pre-determined period of time, the process flow proceeds to step 110, wherein the system of the invention activates a Service Level Agreement (SLA) triggered agent call back to the customer. Contact center agents then call or email the customer who requested the query and provide solutions to the customer. Contact center agents have access to innovative agent desktop applications having intelligent diagnostic tools that enable them to obtain desired information for providing query response to customers. In various embodiments of the present invention, calls by contact center agents to customers are governed by Service Level Agreements (SLAB) between customers and the organization implementing the customer service model disclosed by the invention.

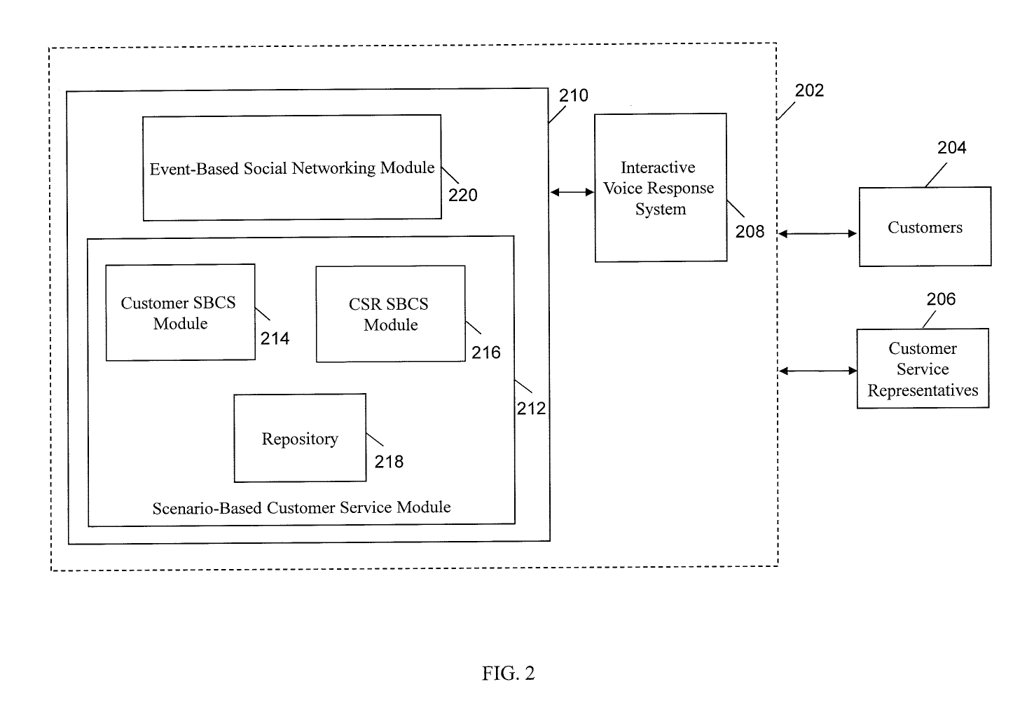

FIG. 2 is a block diagram 200 depicting an integrated customer service platform implemented for providing customer service solutions, in accordance with various embodiments of the present invention. The integrated customer service platform 202 may be implemented by organizations for receiving and processing customer service queries. In various embodiments of the present invention, the integrated customer service platform 202 combines the methodologies of customer self-service, customer peer service and live customer service for providing customer service solutions to customers. Customer self-service comprises web-based support technology to enable customers to access information stored in a knowledge repository and perform various desired operations without any involvement of a Customer Service Representative (CSR). Customer peer-service relies on customers assisting each other through Web 2.0 technologies. Web 2.0 technologies are technologies facilitating online interaction and collaboration between users that includes generation and usage of online content. The generation and usage of online content is implemented through mediums such as social networking websites, blogs, web services, web applications, mashups etc. As shown in the figure, a plurality of customers 204 and a plurality of CSRs 206 interact with integrated customer service platform 202 for obtaining resolution to customer service queries.

In various embodiments of the present invention, the integrated customer service platform 202 comprises an Interactive Voice Response (IVR) System 208 and a web-based software platform 210. Further, the web-based software platform 210 comprises a Scenario-Based Customer Service (SBCS) Module 212 and an Event-Based Social Networking Module 214. IVR System 208 is an automated telecommunication system comprising technology for receiving customer calls and processing customer queries. Once a customer calls IVR System 208, a customer of the plurality of customers 204 is directed to access the web-based software platform 210.

As illustrated in the figure, Customers 204 and Customer Service Representatives 206 access the integrated customer service platform 202 by calling a customer service number of an organization. A customer calling the customer service number for obtaining response to a query is directed to access the organization's website. The customer accesses the website through a user interface. In various embodiments of the present invention, the customer requests for information related to a product/service by submitting a query on the website. When a customer submits a query, the query is routed to the SBCS Module 212. SBCS Module 212 comprises a Customer SBCS Module 214, a CSR SBCS Module 216 and a Repository 218.

Repository 218 is a state of the art knowledge management system which stores one or more ontologies that comprise knowledge related to one or more products or services of an organization. An ontology comprises knowledge related to a product or service in the form of pre-defined scenarios/problems and their resolutions. In an exemplary embodiment of the present invention, for an organization such as a mobile services provider, repository 218 may comprise ontologies related to services such as prepaid, postpaid, billing, audio, video, social networks, software downloads etc. In various embodiments of the present invention, the pre-defined scenarios and their solutions are characterized using Bayesian networks. In an embodiment of the present invention, Customer SBCS Module 214 within the SBCS Module 212 processes a customer query that has been routed to the SBCS Module 212. A relevant ontology located in Repository 218 and based on subject matter of the query is automatically traversed by the Customer SBCS module 214, and the desired information is extracted. The information is then displayed on the user interface to be viewed by the customer. Thus, implementation of Customer SBCS Module 214 for resolving customer service queries illustrates an example of customer self-service.

In various embodiments of the present invention, if a customer query remains unresolved via Customer SBCS module 214, the web-based software platform 210 alerts a suitable CSR having the requisite expertise to address the query. In an embodiment of the present invention, a suitable CSR is alerted by the web-based software platform if the desired information is not obtained within a pre-determined period of time. A CSR 206 then accesses the web-based software platform 210 through a user interface and submits a query to obtain the desired information. The query submitted by the CSR is processed by the CSR SBCS Module 216. A relevant ontology located in Repository 218 and based on subject matter of the query is automatically traversed by the CSR SBCS module 216, and the desired information is extracted and provided to the CSR. The CSR then relays the desired information to the customer by means including, but not limited to, email, telephone call, online text messaging etc.

Event-Based Social Networking Module 220 provides an event-based social networking platform to share knowledge and experience between users to enable problem resolution. In various embodiments of the present invention, the event-based social networking platform implements one or more social networks corresponding to one or more products/services offered by an organization to customers. Users of the one or more social networks include individuals that have subscribed to the one or more social networks. In an embodiment of the present invention, customers subscribe to one or more social networks related to a product/service as part of registering for the product/service.

Event-based Social Networking Module 220 provides an implementation of customer peer-service wherein the customer may leverage the knowledge and expertise of other Customers 204 and Customer Service Representatives 206 to obtain the desired information. A customer desiring information regarding a product or service shares his/her query through a user interface. The query is published to all users of a social network specific to the product/service associated with the query. The users may be one or more of Customers 204 and one or more of Customer Service Representatives 206.

In another embodiment of the present invention, the query is published to one or more selected users that are selected from the social network. The social network maintains information related to each user in a user profile. Further, the social network offers various tools such as communities, discussion forums and blogs which enable users to explore and network with other users with similar interests or users who have expertise in a field of interest. In an embodiment of the present invention, one or more users that are selected from the social network for publishing the query may have been tagged as experts associated with the relevant product/service. In certain embodiments of the present invention, one or more users may rate content published by other users as part of response to query submitted by another user. Tagging of users as experts may be based on average rating of their responses submitted over the social network over a period of time. In yet another embodiment of the present invention, a suitable criterion may be implemented to tag a user as an expert.

In various embodiments of the present invention, one or more users who are selected from the social network for publishing the query may be nominated to evaluate a product related to the customer query. A suitable criterion may be used to nominate the users. For example, users who are active participants in the social network and who have obtained good ratings for their responses submitted on the network may be nominated for responding to customer queries.

In various embodiments of the present invention, once a query is published on the social network, one or more users may then submit responses to the query. The responses are then published on the social network. The customer can then read the query responses and obtain the desired information.

In various embodiments of the present invention, users of the social network may subscribe to various real-time alerts through Really Simple Syndication (RSS) feeds, and the like, to obtain real time updates with regard to new content being added, queries being answered, etc.

An incentive mechanism may be implemented by the integrated customer service platform 202 to encourage users to actively participate in a social network in order to submit queries and to provide answers to queries. In an embodiment of the present invention, functioning of the incentive mechanism is as follows: For each activity that indicates user participation in a social network, the user is assigned certain reward points. For example, the user may be assigned 50 reward points for registering with the integrated customer service platform 202. Further, the user may be assigned 10 reward points for submitting a query to search for desired information in the knowledge repository. Furthermore, the user is assigned 50 points for answering a query submitted by another user. In various embodiments of the present invention, the user may get additional points on the basis of rating of the response, response time (time period during which the response was submitted), etc. In an embodiment of the present invention, reward points that a user accumulates can be redeemed for digital gifts.

In various embodiments of the present invention, the one or more social networks implemented by the event based social networking platform are integrated with Repository 218. The system and method of the present invention enables capturing of knowledge available in the one or more social networks and dynamically updating Repository 218. As a result of dynamic updating of Repository 218, queries submitted by a customer or a customer service representative are accurately addressed by the web-based software platform 210.

In various embodiments, the system and method of the present invention implements predictive models to assess efficacy of the one or more social networks and to determine community dynamics.

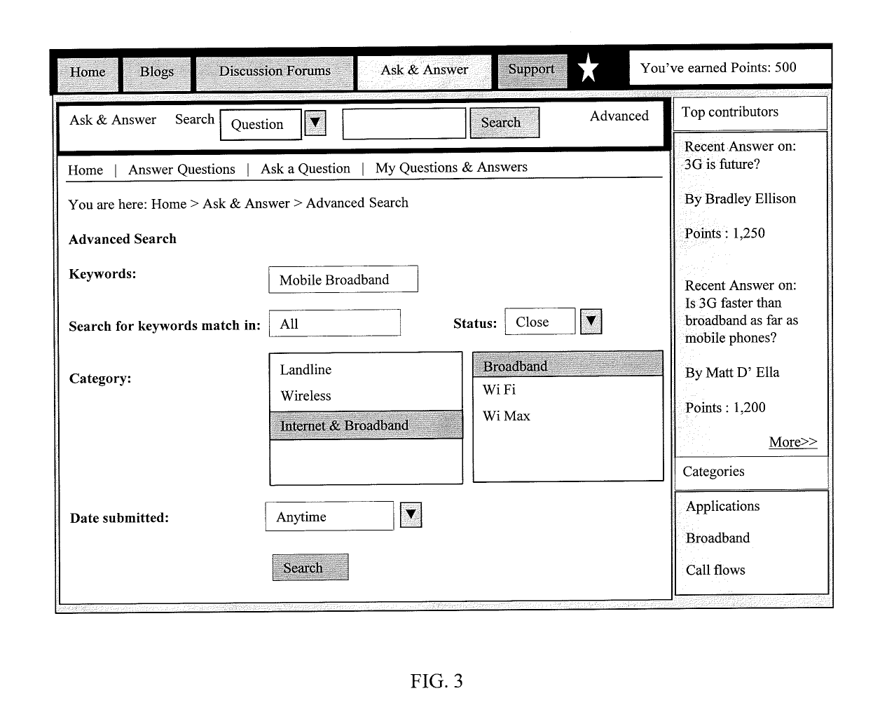

FIG. 3 depicts an exemplary user interface enabling search for desired information on the integrated customer service platform, in accordance with an embodiment of the present invention. The user interface provides functionalities related to submitting queries in knowledge repository of Scenario-based Customer Service module (FIG. 2). As shown in the figure, a user enters one or more keywords related to the subject of interest, i.e. “Mobile Broadband”. Further, the user specifies that all content available in the knowledge repository of SBCS Module should be searched. Furthermore, the user specifies categories for searching, i.e. “Internet & Broadband”, as well as sub-categories within the categories, i.e. “Broadband”.

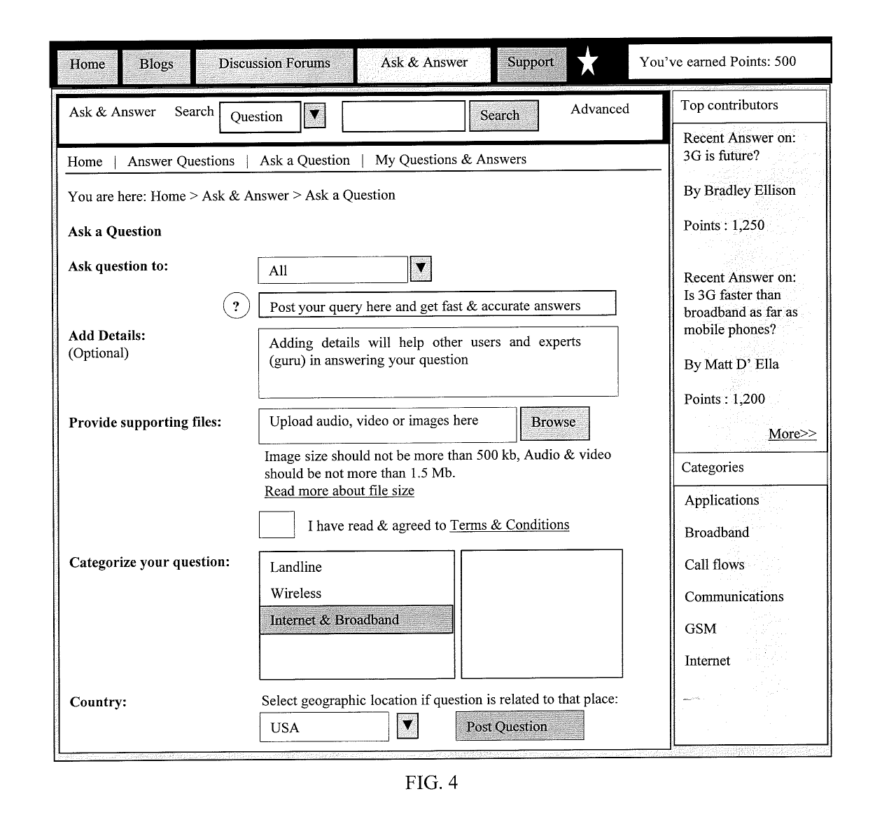

FIG. 4 depicts an exemplary user interface enabling submission of query on a social network of the integrated customer service platform, in accordance with an embodiment of the present invention. A user specifies the users to which the query should be published. The user has the option of selecting “All” or “Experts”. In an exemplary embodiment of FIG. 4, the user selects “All” corresponding to “Ask Question For”. A user can then post the query and add details. Further, the user has the option of attaching relevant files that may assist in better understanding of the problem associated with the query. Furthermore, the user can specify the field of technology, for example, “Internet & Broadband” (shown in the figure) by specifying category of the query up to three levels.

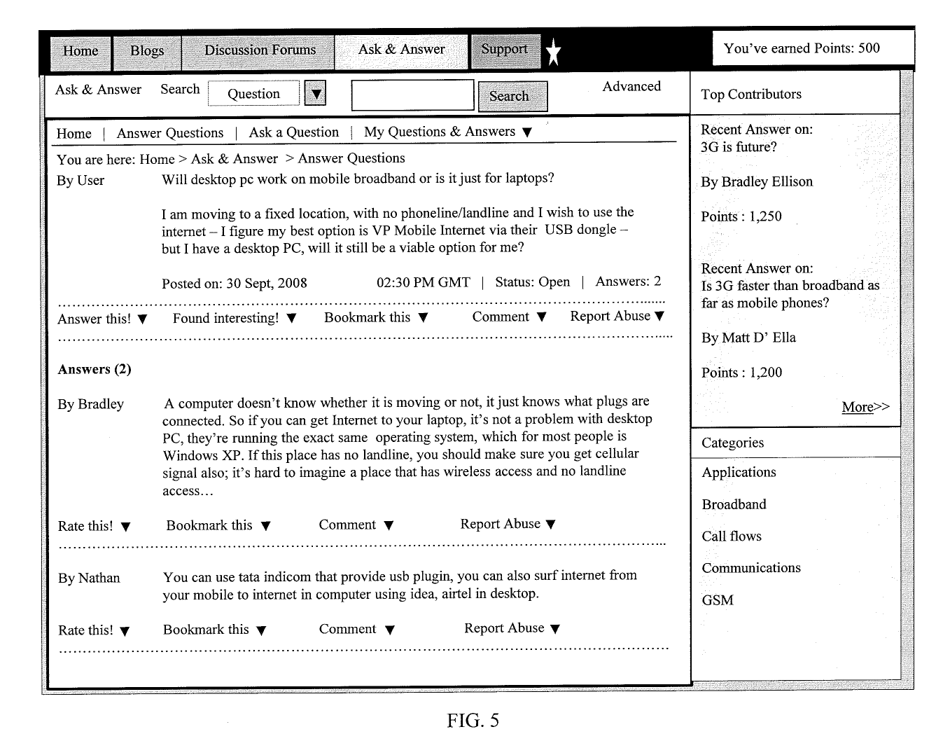

FIG. 5 depicts an exemplary user interface for searching for answers to queries submitted by a user on a social network of the integrated customer service platform. In an embodiment of the present invention, for the purpose of answering queries, a user selects “Answer Questions” tab under “Ask & Answer” and navigates to the user interface of the figure. A user then selects “Questions” corresponding to “Search” and inputs the desired keywords to conduct a search. When the user submits the search query by clicking on “Search” button, a list of recent questions that include the input keywords is displayed along with answers submitted by users of the social network. The figure also illustrates reward points allotted to users of the social network based on answers submitted by the users.

Thus, the system and method of the present invention delivers a superior customer service experience by providing customers with a convenient and emotionally engaging experience. In essence, customers are given the assurance that queries directed to the web-based software platform are addressed without fail. Further, since agents responding to customer queries are provided with agent enablement software tools such as diagnostic tools, productivity of agents is improved and cost of operations is subsequently reduced.

As has been illustrated by the foregoing embodiments, the collaborative customer service model provided to customers for resolving customer service queries is realized using a web-based platform. The foundation for resolving customer service queries includes enabling a web-based platform to provide customers the benefits of web-based self-service, live customer service and peer service. Peer service for resolving queries is enabled using Web 2.0 technologies including, but not limited to, social networking sites, blogs, video sharing sites, mashups, etc.

The method and system for implementing a collaborative customer service model, as described in the present invention or any of the embodiments, may be realized in the form of a computer system. Typical examples of a computer system include a general-purpose computer, a programmed microprocessor, a micro-controller, a peripheral integrated circuit element, and other devices or arrangement of devices that are capable of implementing the steps that constitute the method of the present invention. However, various embodiments of the present invention may be implemented via one or more computer systems. The computer system is not intended to suggest any limitation as to scope of use or functionality of described embodiments.

The computer system typically comprises a computer, a microprocessor, an input device, a display unit and among other units of a computer. The microprocessor is connected to a communication bus. The computer also includes a computer usable medium such as a memory containing computer readable program codes. The memory may include Random Access Memory (RAM) and Read Only Memory (ROM). The computer system further comprises a storage device. The storage device can be a hard disk drive or a removable storage drive such as a floppy disk drive, optical disk drive, etc. The storage device can also be other similar means for loading computer programs or computer readable program code or other instructions into the computer system. The computer system also includes a communication unit. The communication unit allows the computer to connect to other databases and computers on a network through an I/O interface. The communication unit allows the transfer as well as reception of data from other databases. The communication unit may include a modem, an Ethernet card, or any similar device which enables the computer system to connect to databases and networks such as LAN, MAN, WAN, and the Internet. The computer system facilitates inputs from a user through input device, accessible to the system through I/O interface.

The computer system executes a set of instructions that are stored in one or more storage elements to process input data. The storage elements may also hold data or other information, as desired, and may be an information source or physical memory element present in the processing machine. The set of instructions may include various commands that instruct the processing machine to perform specific tasks such as the steps that constitute the method of the present invention. The set of instructions may be in the form of a software program. Further, the software may be in the form of a collection of separate programs, a program module with a larger program or a portion of a program module, as in the present invention. The software may also include modular programming in the form of object-oriented programming The processing of input data by the processing machine may be in response to user commands, results of previous processing or a request made by another processing machine.

The present invention may suitably be embodied as a computer program product for use with a computer system. The method described herein is typically implemented as a computer program product, comprising a set of program instructions for controlling a computer or similar device. The set of program instructions may be a series of computer readable instructions fixed on a tangible medium, such as a computer readable storage medium, for example, diskette, CD-ROM, ROM, or hard disk, or transmittable to a computer system, via a modem or other interface device, over either a tangible medium, including but not limited to optical or analogue communications lines. The implementation of the invention as a computer program product may be in an intangible form using wireless techniques, including but not limited to microwave, infrared or other transmission techniques These instructions can be supplied preloaded into a system or recorded on a storage medium such as a CD-ROM, or made available for downloading over a network such as the Internet or a mobile telephone network. The series of computer readable instructions may embody all or part of the functionality previously described herein. It is contemplated that the computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

1. A method for processing customer service query requested by a customer, wherein the customer service query relates to at least one of one or more products and services, the method comprising:
receiving the customer service query, wherein the customer service query is received through an Integrated Voice Response system;
directing the customer to access a web-based software platform for submitting the query to at least one of an electronic knowledge repository and a social networking software platform;
providing query response to the customer via at least one of the electronic knowledge repository and the social networking platform;
and
automatically routing the query to one or more contact center agents and providing query response via a contact center agent, if the query remains unaddressed via the electronic knowledge repository and the social networking software platform.

2. The method of claim 1, wherein providing query response to the customer via the electronic knowledge repository comprises automatically traversing relevant ontology in the knowledge repository based on subject matter of the query, extracting desired information from the repository and displaying extracted information to the customer on a user interface.

3. The method of claim 1, wherein the electronic knowledge repository comprises one or more ontologies corresponding to one or more products and services, further wherein an ontology contains knowledge related to a product or a service in the form of pre-defined scenarios and their solutions.

4. The method of claim 3, wherein pre-defined scenarios associated with the one or more ontologies are characterized using Bayesian networks.

5. The method of claim 1, wherein providing query response to the customer via social networking software platform comprises:
posting the customer service query to a relevant social network based on subject matter of the query; and
directing the customer to access the social network through a user interface, wherein the social network comprises one or more message boards, further wherein the one or more message boards are configured to publish the query and to publish solutions to the query submitted by subscribers.

6. The method of claim 5 further comprising implementing an incentive mechanism to encourage users to actively participate in the social network in order to submit queries and to provide answers to queries, wherein implementing the incentive mechanism comprises:
assigning reward points to users for performing activities indicating user participation in the social network, wherein the reward points are assigned to users for submitting queries and for answering queries submitted by other users.

7. The method of claim 6, wherein implementing the incentive mechanism further comprises:
allotting additional reward points to users submitting responses to queries based on rating of response and response time; and
facilitating redemption of reward points accumulated by a user in return for digital gifts.

8. The method of claim 1, wherein query response is provided via a contact center agent using online chat sessions.

9. The method of claim 1 further comprising activating a Service Level Agreement triggered contact center agent callback for providing query response to customer.

10. An integrated customer service platform for processing customer service queries related to one or more products and services of an organization, the integrated customer service platform comprising:
an Interactive Voice Response (IVR) system configured to provide audio responses to customers dialing into the system seeking resolution of queries, wherein the IVR system is further configured to direct customers to a web-based software platform for seeking resolution of customer service queries; and
a web-based software platform configured to receive queries submitted by customers through user interfaces and further configured to implement one or more web applications for resolution of queries, the web-based software platform comprising:
a Scenario-based Customer Service (SBCS) Module configured to address queries received by the web-based software platform, the scenario-based customer service module comprising:
a customer SBCS module configured to process customer service queries by extracting the requested information from a repository;
a repository configured to store information related to the one or more products and services in the form of one or more ontologies; and
a customer service representative SBCS module configured to process customer service queries submitted by customer service representatives, wherein the customer service queries are processed by extracting requested information from the repository;
and
an Event-based Social Networking Module configured to implement a social networking platform employing one or more electronic social networks corresponding to the one or more products and services, wherein the one or more electronic social networks are adapted to maintain electronic message boards for receiving and publishing customer queries, and for receiving and publishing responses to queries.

11. The integrated customer service platform of claim 10, wherein the repository is dynamically updated with information available in the one or more electronic social networks.

12. The integrated customer service platform of claim 10, wherein Event-based Social Networking Module is further configured to implement an incentive mechanism to encourage users to actively participate in the one or more electronic social networks for submitting queries and for providing answers to queries, further wherein implementation of the incentive mechanism includes assigning reward points to users for performing activities indicating user participation in the one or more electronic social networks.

13. A computer program product comprising a computer usable medium having a computer readable program code embodied therein for processing customer service query requested by a customer, wherein the customer service query relates to one or more products and services, the computer program product comprising:
program instruction means for receiving the customer service query, wherein the customer service query is received through an Integrated Voice Response system;
program instruction means for directing the customer to access a web-based software platform for submitting the query to at least one of an electronic knowledge repository and a social networking software platform;
program instruction means for providing query response to the customer via at least one of the electronic knowledge repository and the social networking platform;
and
program instruction means for automatically routing the query to one or more contact center agents and providing query response via a contact center agent, if the query remains unaddressed via the electronic knowledge repository and the social networking software platform.

14. The computer program product of claim 13, wherein the step of providing query response to the customer via the electronic knowledge repository comprises program instruction means for automatically traversing relevant ontology in the knowledge repository based on subject matter of the query, extracting desired information from the repository and displaying extracted information to the customer on a user interface.

15. The computer program product of claim 13, wherein the step of providing query response to the customer via social networking software platform comprises:
program instruction means for posting the customer service query to a relevant social network based on subject matter of the query; and
program instruction means for directing the customer to access the social network through a user interface, wherein the social network comprises one or more message boards, further wherein the one or more message boards are configured to publish the query and to publish solutions to the query submitted by subscribers.

16. The computer program product of claim 15 further comprises program instruction means for implementing an incentive mechanism to encourage users to actively participate in the social network in order to submit queries and to provide answers to queries, wherein the step of implementing the incentive mechanism comprises:
program instruction means for assigning reward points to users for performing activities indicating user participation in the social network, wherein the reward points are assigned to users for submitting queries and for answering queries submitted by other users.

17. The computer program product of claim 16, wherein the step of implementing the incentive mechanism further comprises:
program instruction means for allotting additional reward points to users submitting responses to queries based on rating of response and response time; and
program instruction means for facilitating redemption of reward points accumulated by a user in return for digital gifts.

18. The computer program product of claim 13 further comprises program instruction means for activating a Service Level Agreement triggered contact center agent callback for providing query response to customer.
